(19) United States
(12) Patent Application Publication
(10) Pub. No.: US 2011/0259033 A1
(43) Pub. Date: Oct. 27, 2011

(54) MOVEMENT-SENSITIVE ICE AND WATER DISPENSING IN AN APPLIANCE

(75) Inventor: Kurt Froehlich, Easely, SC (US)

(73) Assignee: ELECTROLUX HOME PRODUCTS, INC., Cleveland, OH (US)

(21) Appl. No.: 12/768,211

(22) Filed: Apr. 27, 2010

(51) Int. Cl. F25D 23/04; B67D 3/02

(52) U.S. Cl. 62/344; 62/389

(57) ABSTRACT

An appliance for dispensing product is provided including a storage compartment located within the appliance, a dispensing unit located on the exterior of the appliance including a dispensing outlet, and an actuating mechanism located on the exterior of the storage compartment. The actuating mechanism is configured to be moved from a neutral position to at least a first position and a second position. The first position is configured to trigger a release of a first type of product, and the second position is configured to release a second type of product, respectively, from the dispensing outlet. In one example, a switch can be provided to detect the position of the actuating mechanism, and each position triggers the release of a different type of product from within the appliance.

### BACKGROUND OF THE INVENTION

The present invention relates generally to refrigeration appliances and in particular to ice and water dispensing units in an appliance.

Modern refrigeration appliances, such as household refrigerators for example, often include as one of their features a dispensing unit for water and/or ice. Frequently, the dispensing unit is located within a recess in the exterior surface of a door of the appliance. A lever can be provided for the water dispensing outlet that is pivotally attached to the dispensing unit. A spring or the like can bias the lever outwardly. When water is to be dispensed, a glass or other container is pressed against the lever thereby operating a switch or sensor so as to complete an electrical circuit between a source of electrical power and a solenoid-operated valve connected to a source of water. The completion of the electrical circuit opens the solenoid-operated valve permitting the water to flow form the source of water to the water dispensing outlet. When the desired amount of water has been dispensed, the glass is withdrawn from the lever, the torsion spring causes the switch or sensor to be disengaged and the electrical circuit deactivated so that the solenoid-operated valve closes. Similar structure can also be provided for an ice dispenser. Typically, separate levers are provided for ice dispensing and water dispensing.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, an appliance for dispensing product is provided including a storage compartment located within the appliance, a dispensing unit located on an exterior of the appliance where the dispensing unit includes a dispensing outlet, and an actuating mechanism located on the exterior of the storage compartment. The actuating mechanism is configured to be moved from a neutral position to at least a first position and a second position. The first position is configured to trigger a release of a first type of product from the dispensing outlet. The second position is configured to trigger a release of a second type of product from the dispensing outlet.

In accordance with another aspect of the present invention, an appliance for dispensing product is provided including a storage compartment, and an actuating mechanism located on the exterior of the storage compartment. The actuating mechanism is configured to be moved from a neutral position to at least a first position and a second position. The first position is configured to trigger a release of a first type of product. The second position is configured to trigger a release of a second type of product. The first position is reached by moving the actuating mechanism from the neutral position in a first direction. The second position is reached by moving the actuating mechanism from the neutral position further in the first direction.

In accordance with another aspect of the present invention, an appliance for dispensing product is provided including a storage compartment located within the appliance, a door configured to provide access to the storage compartment, a recess located on the exterior of the door, a dispensing unit located in the recess where the dispensing unit includes a dispensing outlet, an actuating mechanism located on the exterior of the storage compartment, a first line and a second line located within the appliance that are each configured to transport a product to the dispensing outlet, at least one valve configured to control which of the first line and the second line communicates with the dispensing outlet, and at least one switch configured to detect a position of the actuating mechanism. The actuating mechanism is configured to be moved from a neutral position to at least a first position and a second position by moving the actuating mechanism. The first position is configured to trigger a release of at least a first type of product from the dispensing outlet by the switch sending a signal indicative of the position of the actuating mechanism to the valve. The second position is configured to trigger a release of at least a second type of product from the dispensing outlet by the switch sending a signal indicative of the second position of the actuating mechanism to the valve.

### BRIEF DESCRIPTION OF THE SEVERAL VIEWS OF THE DRAWINGS

The foregoing and other aspects of the present invention will become apparent to those skilled in the art to which the present invention relates upon reading the following description with reference to the accompanying drawings, in which:

FIG. 1 is a perspective view of an example refrigerator and freezer apparatus that includes a dispensing unit;

FIG. 2 is a side view of a section of the refrigerator and the dispensing unit of FIG. 1 that further includes an example actuating mechanism;

FIG. 3 is a side view of the actuating mechanism of FIG. 2 illustrated in different example positions; and

FIG. 4 is a side view of another example an actuating mechanism.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

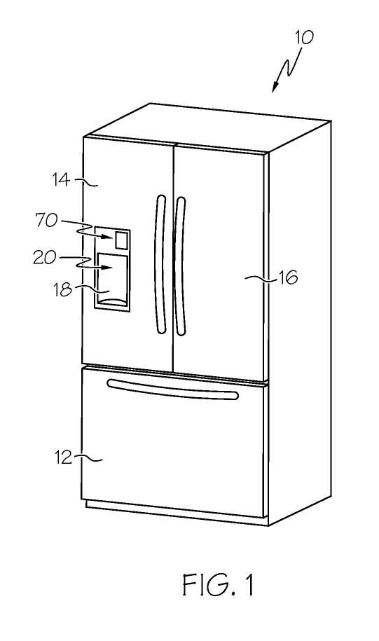

FIG. 1 shows an example appliance. The example appliance 10 can be a refrigerator-freezer with a freezer compartment 12 located in the lower portion and a refrigerator or fresh food compartment 16 located in the upper portion. The freezer compartment 12 is used to freeze and/or maintain articles of food stored within the storage compartment of the appliance in a frozen condition. The fresh food compartment 16 serves to keep articles of food stored in the fresh food compartment 16 from spoiling by maintaining the articles of food at a cool temperature that is somewhat above zero degrees Celsius so as not to freeze the articles of food. Other example appliances can be used such as various types of refrigerators with various storage compartments and the use of the present invention is not limited to refrigerators of the type specifically shown in FIG. 1. For example, a refrigerator can be provided that has the freezer compartment located in the upper portion of the refrigerator above the fresh food compartment that is located in the lower portion of the refrigerator. Additionally, side-by-side refrigerators can also be provided where the freezer compartment is located on one side of the refrigerator and the fresh food compartment is located on the opposite side of the refrigerator. In further examples, the appliance can have only a single storage compartment, such as a fresh food compartment or a freezer compartment.

The appliance 10 in FIG. 1 includes the freezer compartment 12 located in the lower portion of the appliance 10 and the fresh food compartment 16 located in the upper portion of the appliance 10. Access to the fresh food compartment 16 is had through the double doors, or French doors 14. The freezer compartment 12 can also have a variety of doors to provide access. Water and ice can be dispensed through a dispensing unit 18 that can be located in a recess 20 of the door 14. Alternatively, the dispensing unit 18 can be located on the door of the freezer compartment 12 or at any point on the exterior or on the interior of the appliance.

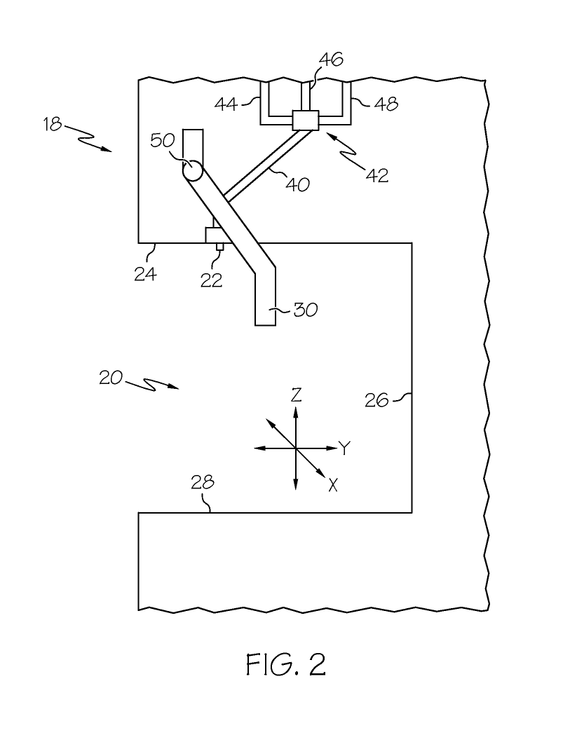

As shown in FIG. 2, the dispensing unit 18 can include a dispensing outlet 22 that can be located on an upper surface 24 of the dispensing unit 18. The dispensing outlet 22 in this example protrudes downwards from the upper surface 24 but in other examples it can be nested in the upper surface 24. In other examples, the dispensing outlet 22 can be located on other surfaces, such as the rear surface 26 of the dispensing unit 18 or on the side surfaces of the dispensing unit 18. The dispensing unit 18 can further include a drain (not shown) on the bottom surface 28 on the dispensing unit 18. The drain can be configured for receiving and/or draining away excess water or ice from the dispensing outlet 22.

As further shown in FIG. 2, the dispensing unit 18 can also be provided with an actuating mechanism 30. The actuating mechanism 30 can be disposed variously within the recess 20. For example, the actuating mechanism 30 can extend from the rear surface 26, the bottom surface 28, or any other surface of the recess 20. The actuating mechanism 30 can include various structure, such as a lever, a paddle, an arm, or another object that can be pushed, pulled, or rotated into multiple positions. The actuating mechanism 30 can also have a surface that receives or engages a cup or other container. The actuating mechanism 30 can be actuated by a user pushing a cup or other container against the surface of the actuating mechanism 30.

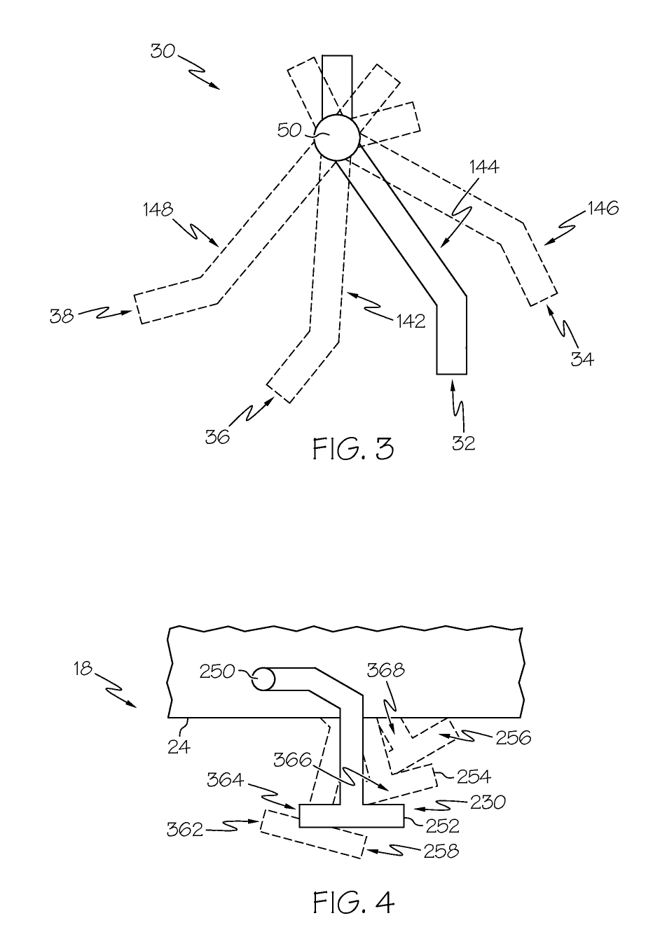

As shown in FIG. 3, the actuating mechanism 30 is configured to be moved to at least two positions (i.e. 34, 36, 38) from a neutral position 32. The at least two positions can include a first position 34 and a second position 36. In FIG. 3, a plurality of different example positions is shown for the actuating mechanism 30. It is appreciated that the shape of the actuating mechanism 30 in this example is but one example shape that the actuating mechanism 30 can have. The actuating mechanism 30 includes a neutral position 32 for the actuating mechanism 30 that is configured to be a position that the actuating mechanism 30 rests when no external force, such as by a user, is applied to the actuating mechanism 30. Thus, in the neutral position 32, the actuating mechanism 30 does not call upon the valve 42 to release any products. The first position 34 of the actuating mechanism 30 is configured to trigger or actuate a release of at least one type of product from the dispensing outlet, and the second position 36 of the actuating mechanism is configured to trigger or actuate a release of a second type of product from the dispensing outlet. In one example, the first position 34 for the actuating mechanism 30 can actuate the release of a first type of product, such as water of a first temperature, from within the appliance. The second position 36 for the actuating mechanism 30 can actuate the release of a second type of product, such as water of a second temperature.

In still further examples, a plurality of actuating mechanisms can be provided, such as a first actuating mechanism configured to deliver different types of ice and a second actuating mechanism configured to deliver different types of water. In one example, a first actuating mechanism 30 can be provided to trigger a release of at least a first type of product and a second type of product and a second actuating mechanism (not shown) can be provided to provide at least a third type of product and a fourth type of product. For example, the first actuating mechanism 30 can deliver cold water in a first position 34 and hot water in a second position 36 and the second actuating mechanism can deliver cubed ice in a first position and crushed ice in a second position. In further examples, any number of actuating mechanisms with any number of positions can be used to trigger a release of different types of products from a dispensing outlet. Each actuating mechanism 30 can include at least a first position 34 and a second position 36 where the first position 34 actuates a first type of product and the second position 36 actuates a second type of product.

In any of the examples, the first position 34 can be reached by moving the actuating mechanism 30 from the neutral position 32. The first position 34 can also be reached by moving the actuating mechanism 30 in a first direction from the neutral position 32. The first direction, in the shown example refers to pulling the actuating mechanism 30 in a backwards direction away from the rear surface 26 of the dispensing unit 18.

In one example, at least one of the first position 34 and the second position 36 can be reached by moving the actuating mechanism 30 in any direction from the neutral position 32. In another example, the first position 34 is reached by moving the actuating mechanism 30 in the first direction away from the neutral position and the second position 36 is reached by moving the actuating mechanism 30 in the second direction away from the neutral position 32. The first direction can be directly opposite the second direction or can merely be a different direction compared to the first direction.

The at least two positions of the actuating mechanism 30 can further include a third position 38. The third position 38 for the actuating mechanism 30 can actuate the release of a third product, such as cubed ice from within the appliance 10. The third position 38 can be reached by moving the actuating mechanism 30 from the neutral position 32. The third position 38 can be reached by moving the actuating mechanism 30 in the first direction, in the second direction, or in a third direction. For example, the third position 38 can be reached by movement of the actuating mechanism 30 in a second direction from the second position 36, such as to a position in the second direction relatively further away from the neutral position 32 than the second position 36. Thus, in this example, the second position 36 and the third position 38 are located in one directional movement from the actuating mechanism 30, and the first position 34 is located in another directional movement from the actuating mechanism 30. Thus, the different positions can also be located at different angles relatives to each other or can be in a direction of movement that is perpendicular to each other. In still further examples, the third position 38 can only be reached by moving the actuating mechanism 30 from only one of the neutral position 32, the first position 34, or the second position 36.

In further examples, the first position 34, the second position 36, and the third position 38 can correspond to moving the actuating mechanism 30 in different planes and in a variety of directions. For example, the first position 34 can be reached by moving the actuating mechanism 30 from the neutral position 32 in a direction to the left, to the right, to the front, to the rear, or in any three-dimensional direction defined by the x-axis, the y-axis, and the z-axis shown in FIG. 2. Any direction of movement can be used along the x-axis, the y-axis, or the z-axis shown in FIG. 2 or an angular direction between the x-axis, the y-axis, or the z-axis, to reach a different position 34, 36, 38 for the actuating mechanism 30. In one example, the first position 34 and the second position 36 can be reached by movement in a first direction that is along a y-axis and a second direction that is opposite the first direction along a y-axis, where the third position is reached by movement in a third direction along a z-axis. Accordingly, the first position 34 can also be reached by moving the actuating mechanism 30 in any vertical direction, horizontal direction, or by moving the actuating mechanism 30 in any forward direction or rearward direction. Thus, the first position 34 can be reached by moving the actuating mechanism 30 in any three-dimensional direction, such as a first three-dimensional direction. The second position 36 can be reached by moving the actuating mechanism 30 in a second three-dimensional direction. The second three-dimensional direction can be the same as the first three-dimensional direction, it can be the opposite of the first three-dimensional direction, or it can be a completely different three-dimensional direction. In one example, the second position 36 can be reached by rotating the actuating mechanism 30 about its pivot point further in the forward direction, by rotating the actuating mechanism 30 in a rearward direction, or by rotating the actuating mechanism 30 in a sideways direction. In further examples, the actuating mechanism can also be rotated about its pivot point 50 along its longitudinal axis to reach at least two different positions. The pivot point 50 is adapted to permit movement in a plurality of directions. In one such example, the actuating mechanism can be rotated a number of degrees, such as 90 degrees, about its longitudinal axis such that the actuating mechanism faces a different direction to trigger the release of a different type of product. In any of the examples, the actuating mechanism is configured to move in any direction and be rotated about the pivot point in any direction or orientation.

The different types of products that can be released can be water, ice, crushed ice, cubed ice, a variety of liquid beverages, or other solid or liquid products. In one example, when there are two positions provided, such as positions 34 and 36, the first type of product can be a first type of ice (e.g., cubed ice) transported from a storage compartment within the appliance, and the second type of product can be a second type of ice (e.g., crushed ice) transported from the storage compartment within the appliance. By providing an actuating mechanism 30 movable between different selection positions, selection icons and other tactile switches can be reduced, or even eliminated, to determine the type of product for release. Reducing the need for selection icons and other tactile switches thereby reduces the amount of user-interface space needed in the appliance and increases the amount of space that can be used for other icons or functions. A user can simply place their cup or container within the dispensing unit 18 and move the actuating mechanism 30 to the appropriate position with the cup or container to dispense the desired product.

An ice-making system can be operationally associated with the dispensing unit 18 by a dispensing conduit (not shown) for dispensing ice from the ice-making system to the dispensing unit 18 when the door 14 is closed. The dispensing conduit can be mounted to the side of the door 14 that faces the interior of the fresh food compartment 16 when the door 14 is closed and includes an opening for receiving ice cubes from a storage bin. A control panel can be operationally associated with various control units and devices in the refrigerator. For example, the control panel can be used to provide input or control information for controlling the operation of various components in the refrigerator, such as the dispensing unit 18 and/or the ice-making system. The control panel can be analog or digital, and may operatively coupled to a microprocessor or the like (not shown). Thus, the user can adjustably control various operational features of the refrigerator at the control panel. The functioning of the microprocessor is also responsive to condition-sensing devices, such as digital devices, analog devices, or thermostats, located in the refrigerator.

The refrigeration system can include a first evaporator (not shown) adapted to be operatively associated with the freezer compartment of the refrigerator for furnishing to the freezer compartment a cooling effect sufficient to maintain the freezer compartment at a temperature below zero degrees Centigrade. The evaporator can be located inside the freezer compartment but need not be located there. The refrigeration system can also include a second evaporator (not shown) in operative association with the ice-making unit of the ice-making system for furnishing to the ice-making unit a cooling effect sufficient to freeze water and form ice in the ice-making unit.

The ice-making system can be adapted to operate within a freezer compartment or even with a section of a refrigeration appliance that is maintained at a temperature above zero degrees Centigrade, such as the fresh food compartment 16 of the refrigerator 10. The ice-making unit of the ice-making system can be adapted to be placed in operative association with a refrigeration system, for furnishing to the ice-making unit a cooling effect sufficient to freeze water and form ice in the ice-making unit. In one example, the ice-making system can include an ice-making tray in which ice is formed around ice-making elements (not shown). In addition to the ice-making unit, the ice-making system can include a reservoir for holding water. Refrigerant can either be brought into general contact with the ice-making elements, and the elements cooled thereby, or the refrigerant can be placed into more complete contact with the elements by passing the refrigerant internally of the elements. In other examples, the ice-making system can have an ice tray that is filled with water to form ice cubes. In any event, the refrigerant will be at a temperature sufficiently low to cause the water in the ice-making tray to freeze. Hot or warm compressed refrigerant can contact the ice-forming elements to cause the ice pieces to be freed from the plurality of ice-making elements. However, prior to this occurring, as controlled by the microprocessor, a dumping mechanism can rotate the ice-making tray and dump from the ice-making tray any water in the ice-making tray that has not been converted to ice.

Turning back to FIG. 2, the dispensing unit 18 can further include structure to dispense the selected product. FIGS. 2-4 are intended as schematic illustrations only of the structure described herein. For example, the structure for dispensing the selected product can include a supply line 40 that extends from the dispensing outlet 22 to a valve 42. The valve 42, such as a three-way valve, receives products from a first line 44, a second line 46, and a third line 48. In further examples, a different plurality of lines, such as two or even four or more lines, can be provided to the valve 42, and/or a plurality of valves (not shown) can be provided. Each line 44, 46, and 48, can transport different types of products such as different liquids, different types of ices, and/or different other products to the dispensing outlet 22. The first line 44, the second line 46, and the third line 48 can each have a different size and orientation. Moreover, one or more of the lines can be configured to transport ice from either the freezer compartment 12 or the fresh food compartment 16. A source of water (not shown) can be provided within the appliance 10 or can be provided by a water supply system of the household or place of business that the appliance 10 is installed in.

The valve 42 can be a solenoid-operated valve or part of a mechanical system and operation can be controlled by a microprocessor. The valve 42 is configured to control an opening to determine which of the first line 44, the second line 46, and the third line 48 communicates with the dispensing outlet 22. The microprocessor can receive a signal based on the detected position of the actuating mechanism 30. A switch, such as a microswitch, can be provided on or near the actuating mechanism 30. The switch is configured to detect the position (i.e. 34, 36, 38) of the actuating mechanism 30 and sends a signal indicative of the position of the actuating mechanism 30 to activate the valve 42 for the release of one of the types of product corresponding to the specific position selected. The signal can be analog, digital, can merely provide electrical contacts, or the signal can be a part of a mechanical system that indicates the position of the actuating mechanism 30. In other examples, a plurality of dispensing outlets can be provided (not shown), where each dispensing outlet is in engagement with a different line for the delivery of a different type of product. The dispensing outlets can be located close enough together that a user can receive the various types of product by the user placing a cup or container in contact with the actuating mechanism 30. In further examples, a plurality of valves (not shown) can also be used to actuate the transport of the various types of products to the dispensing outlet based on the selected position of the actuating mechanism 30.

In another example shown in FIG. 3, the actuating mechanism 30 can be biased to have a different position representing a neutral position 142. For example, the at least two positions can include a first position 144, a second position 146, and a third position 148. The first position 144 can be reached by movement of the actuating mechanism 30 in a first direction from the neutral position 142. The second position 146 can be reached by movement of the actuating mechanism 30 in the first direction from the first position 144. In this example, the third position 148 can be reached by movement of the actuating mechanism in a second direction from the neutral position 142. Thus, in this example, the first position 144 and the second position 146 are located in one directional movement from the actuating mechanism 30 and the third position 148 is located in another directional movement from the actuating mechanism 30. It is appreciated that other arrangements for the various positions can also be provided, such as different neutral positions and/or directions of movement, that would allow a user to quickly learn how to dispense a plurality of products from a plurality of positions of the actuating mechanism 30.

In the example of FIG. 3, the actuating mechanism 30 is configured to rotate about a pivot point 50. The pivot point 50 can be located at various locations along the actuating mechanism 30. Thus, in this example, the movement of the actuating mechanism 30 in the first direction can correspond to a counter-clockwise rotational direction. It is appreciated that in other examples, the actuating mechanism 30 can be mounted in different orientations with or without a pivot point. In one example of an actuating mechanism 30 with a pivot point, the actuating mechanism 30 is configured to have a rotational movement in one plane. In another example, a pivot point can be provided that allows the actuating mechanism 30 to move in all three-dimensions. This example can correspond to where the actuating mechanism 30 is suspended by the pivot point and a user can move the actuating mechanism 30 forwardly, rearwardly, or even sideways.

The appliance of FIG. 1 can further include an indicator mechanism 70 on the exterior of the appliance. The location, shape, and size of the indicator mechanism 70 in FIG. 1 is by way of example only, and the indicator mechanism 70 can also be placed in other locations with other shapes and sizes. The at least one indicator mechanism 70 is configured to provide an indication, such as a visual or auditory indication. The indication communicates to the user which type of product is being dispensed from the dispensing outlet in response to the current selected position of the actuating mechanism 30. The visual indication can be located on a user interface of the appliance. For example, if the actuating mechanism 30 is in a neutral position 32, the indicator mechanism 70 may not display any messages or signals. However, in one example, when the actuating mechanism 30 is in the first position 34 that actuates the release of water from within the appliance, the indicator mechanism 70 can display a message indicating that water is being released. In another example, the indicator mechanism 70 can activate a small light that indicates that water is being released. The indicator mechanism 70 can include various display mechanisms with each picture, graphic, text, or indicia to indicate that a certain type product is being released in response to a certain position 34, 36, 38 being reached. The indicator mechanism 70 thus provides feedback to a user operating the appliance 10 as to which product is being released by a current position of the actuating mechanism 30. In further examples, the indicator mechanism 70 can display an indication, such as a visual graphic or text or indicia, to indicate which type of product will be released from the dispensing outlet based on a future position 34, 36, 38 of the actuating mechanism 30. The user can observe the indicator mechanism 70, such as the indicia, before selecting the position 34, 36, 38 to release a certain type of product. The indicator mechanism 70 thus can provide the user with guidance for selecting a certain position of the actuating mechanism 30 to release a desired type of product. In the example where the indicator mechanism 70 is indicia, the indicia can be graphical messages, such as graphical messages provided by a video screen, graphical messages printed on the exterior of the appliance, and/or graphical messages molded as a part of the exterior of the appliance.

Turning now to FIG. 4, which is similar to FIG. 3, a second example of an actuating mechanism 230 is provided, where a different arrangement of positions is provided. In this example, the actuating mechanism 230 can be mounted such that the actuating mechanism 230 can be moved from a neutral position 252 along a first direction to the first position 254, along the same first direction to the second position 256, and along a second direction to the third position 258. The second example actuating mechanism 230 can be mounted below the upper surface 24 of the dispensing unit 18. Though not shown, the dispensing outlet can be similar to that shown and discussed relative to FIG. 2, and can be provided either within the actuating mechanism 230 or at a location on the exterior of the actuating mechanism 230, such as in front of or behind the actuating mechanism 230 in the view of FIG. 4. A user can place a cup or other container into contact with the actuating mechanism 230. A neutral position 252 for the actuating mechanism 230 is achieved when the actuating mechanism 230 is in a resting state. Thus, in the neutral position, the actuating mechanism 230 does not call the valve 42 to release any products.

The actuating mechanism 230, in this example, can then be moved in a generally upwards direction from the neutral position 252 to reach a first position 254. The actuating mechanism 230 can also be moved in the generally upwards direction from the neutral position 252 to reach a second position 256, such as by a user placing a cup or container in contact with the actuating mechanism 230. A third position 258 can also be provided to release a third type of product. In this example, the third position 258 can be located in a generally downwards direction from the neutral position 252.

In yet another example, the neutral position 362 can be modified such that the actuating mechanism 230 moves in a single direction. A third position 368 can be located in a generally upwards direction from the second position 366. Thus, the movement of the actuating mechanism 250 in the first direction from the first position 364 can be used to reach the third position 368. In further examples, the first position 364, the second position 366, and the third position 368 can be located in various arrangements relative to the neutral position 362. For example, each of the first, second, or third positions can be located above or below the neutral position 362. In another example, any two positions (i.e. 364, 366 or 364, 368 or 366, 368) can be located either above or below the neutral position 362.

The actuating mechanism 230 can be configured to be rotatable about a pivot point 250 for movement to different positions in a relatively vertical direction. In another example, the actuating mechanism 230 can be configured to be moved in only an upwards direction and a downwards direction. For example, the actuating mechanism 230 can be connected via one or more linkage members to a pivot point to allow the actuating mechanism 230 to move in only one direction, such as a vertical direction, as opposed to pivoting about a central point.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An appliance for dispensing product including:
a storage compartment located within the appliance;
a dispensing unit located on an exterior of the appliance wherein the dispensing unit includes a dispensing outlet;
an actuating mechanism located on the exterior of the storage compartment,
wherein the actuating mechanism is configured to be moved from a neutral position to at least a first position and a second position; and
wherein the first position is configured to trigger a release of a first type of product from the dispensing outlet, and where the second position is configured to trigger a release of a second type of product from the dispensing outlet.

2. The appliance according to claim 1,
wherein the first position is reached by moving the actuating mechanism in a first direction and the second position is reached by moving the actuating mechanism in a second direction that is different than the first direction.

3. The appliance according to claim 2,
wherein the first direction is a first three-dimensional direction and wherein the second direction is a second three-dimensional direction.

4. The appliance according to claim 1,
wherein the actuating mechanism is configured to rotate about a pivot point to move to the first position and the second position.

5. The appliance according to claim 1,
wherein the actuating mechanism is configured to be moved from the neutral position to a third position that is configured to trigger a release of a third type of product from the dispensing outlet.

6. The appliance according to claim 5,
wherein the first position is reached by moving the actuating mechanism in a first direction and the second position is reached by moving the actuating mechanism in a second direction that is different than the first direction; and
wherein the third position is reached by moving the actuating mechanism from the neutral position in a third direction from the neutral position.

7. The appliance according to claim 1, further including:
an indicator mechanism located on the exterior of the appliance, wherein the indicator mechanism is configured to provide an indication as to which type of product will be released from the dispensing outlet based on a future position of the actuating mechanism.

8. The appliance according to claim 1, further including:
an indicator mechanism located on the exterior of the appliance, wherein the indicator mechanism is configured to provide an indication as to which type of product is currently being released from the dispensing outlet based on a current position of the actuating mechanism.

9. An appliance for dispensing product including:
a storage compartment; and
an actuating mechanism located on the exterior of the storage compartment,
wherein the actuating mechanism is configured to be moved from a neutral position to at least a first position and a second position and the first position is configured to trigger a release of a first type of product and the second position is configured to trigger a release of a second type of product;
wherein the first position is reached by moving the actuating mechanism from the neutral position in a first direction; and
wherein the second position is reached by moving the actuating mechanism from the neutral position further in the first direction.

10. The appliance according to claim 9,
wherein the first position for the actuating mechanism triggers the release of at least one of water, crushed ice, or cubed ice from within the appliance.

11. The appliance according to claim 9, further including:
a third position for the actuating mechanism wherein the third position triggers the release of a third type of product from within the appliance; and
wherein the third position is reached by moving the actuating mechanism from the neutral position in a second direction that is different than the first direction.

12. The appliance according to claim 9, further including:
a third position for the actuating mechanism wherein the third position triggers the release of a third type of product from within the appliance; and
wherein the third position is reached by moving the actuating mechanism in the first direction from the second position.

13. The appliance according to claim 9, further including:
an indicator mechanism located in the exterior of the appliance, wherein the indicator mechanism is configured to provide an indication as to which type of product will be released from the dispensing outlet based on a future position of the actuating mechanism.

14. The appliance according to claim 9, further including:
an indicator mechanism located on the exterior of the appliance, wherein the indicator mechanism is configured to provide an indication as to which type of product is being released from the dispensing outlet based on a current position of the actuating mechanism.

15. An appliance for dispensing product including:
a storage compartment located within the appliance;
a door configured to provide access to the storage compartment;
a recess located on the exterior of the door;
a dispensing unit located in the recess wherein the dispensing unit includes a dispensing outlet;
an actuating mechanism located on the exterior of the storage compartment;
a first line and a second line located within the appliance that are each configured to transport a product to the dispensing outlet;
at least one valve configured to control which of the first line and the second line communicates with the dispensing outlet; and
at least one switch configured to detect a position of the actuating mechanism, wherein the actuating mechanism is configured to be moved from a neutral position to at least a first position and a second position by moving the actuating mechanism, and
wherein the first position is configured to trigger a release of at least a first type of product from the dispensing outlet by the switch sending a signal indicative of the first position of the actuating mechanism to the valve and wherein the second position is configured to trigger a release of at least a second type of product from the dispensing outlet by the switch sending a signal indicative of the second position of the actuating mechanism to the valve.

16. The appliance according to claim 15,
wherein the actuating mechanism is configured to rotate about a pivot point to move to the at least two positions.

17. The appliance according to claim 15,
wherein the first position triggers the release of a first type of product from within the appliance and the first position is reached by moving the actuating mechanism in a first direction from the neutral position; and
wherein the second position triggers the release of a second type of product from within the appliance and the second position is reached by moving the actuating mechanism in a second direction from the neutral position.

18. The appliance according to claim 15, further including:
a third position for the actuating mechanism wherein the third position triggers the release of a third type of product from within the appliance; and
wherein the third position triggers the release of a third type of product from within the appliance and the third position is reached by moving the actuating mechanism from the neutral position.

19. The appliance according to claim 15, further including:
an indicator mechanism located on the exterior of the appliance, wherein the indicator mechanism is configured to provide an indication as to which type of product will be released from the dispensing outlet based on a future position of the actuating mechanism.

20. The appliance according to claim 15, further including:
an indicator mechanism located on the exterior of the appliance, wherein the indicator mechanism is configured to provide an indication as to which type of product is being released from the dispensing outlet based on a current position of the actuating mechanism.
